(19) United States
(12) Patent Application Publication
(10) Pub. No.: US 2025/0229503 A1
(43) Pub. Date: Jul. 17, 2025

(54) METHOD FOR PRODUCING A HYBRID ONE-PIECE COMPOSITE STRUCTURE AND DOOR PRODUCED BY SAID METHOD

(71) Applicant: LATECOERE, Occitanie Toulouse (FR)

(72) Inventor: Christophe PERRIER, Occitanie Toulouse (FR)

(73) Assignee: LATECOERE, Occitanie Toulouse (FR)

(21) Appl. No.: 18/854,534

(22) PCT Filed: Mar. 27, 2023
(86) PCT No.: PCT/EP2023/057831

§ 371 Date: Oct. 6, 2024

(30) Foreign Application Priority Data
Apr. 7, 2022 (FR) FR2203171

(51) Int. Cl. B29D 99/00; B29C 70/44; B29C 70/54; B29L 31/30; B64C 1/14

(52) U.S. Cl. CPC B29D 99/0014; B29C 70/44; B29C 70/545; B64C 1/1407; B29L 2031/3076

(57) ABSTRACT

Process for manufacturing a composite stiffened structure including a panel (3) and at least one stiffener (4). The manufacturing process includes the following steps to obtain a one-piece core (2): fiber draping of the elements of the panel (3) and the stiffeners (4); assembly of the elements of the stiffeners (4) on the panel (3); curing of the assembly and obtaining the monoblock core (2); machining of the monoblock core (2); manufacture of additional structural elements intended to stiffen the stiffened structure and to support installation parts; combination of the additional structural elements with the machined monoblock core (2).

### CROSS REFERENCE TO RELATED APPLICATION

This application is a national stage entry of PCT/EP2023/057831 filed Mar. 27, 2023, under the International Convention and claiming priority over French Patent Application No.FR2203171 filed Apr. 7, 2022.

### TECHNICAL FIELD OF THE INVENTION

The invention relates to a process for manufacturing a hybrid monoblock composite structure, i.e. a structure of which at least one part is monoblock.

The invention also relates to a door made using this manufacturing process. In particular, doors for vehicles—aircraft, trains, automobiles, ships—and buildings are intended to be manufactured using this process.

In the aeronautics industry in particular, aircraft doors allow people and equipment to enter and leave the aircraft cabin. These doors are subject to numerous constraints, and are fitted with a wide range of equipment. Their mass production requires optimization of manufacturing flows and raw materials.

### PRIOR ART

An aircraft door is made by assembling many separate parts to meet the needs of its complex structure. In fact, such a door is integrated into the fuselage and creates a partition between the interior of the aircraft, the cabin, and the outside environment. During the flight of such an aircraft, the pressure difference between the cabin and the outside environment remains significant, subjecting the door to numerous stresses. An aircraft door also carries equipment such as opening and locking mechanisms, safety devices and other equipment that are attached to the door. To meet these requirements, the structure of such a door is generally made up of a panel machined and/or shaped to the dimensions of the door frame, this panel being stiffened with stiffening inserts and assembled using mechanical fasteners.

Traditionally, panels and stiffeners are made of metal: the mechanical properties of metals ensure that door components are robust enough to fulfill their role as interiorexterior interface, and to support the weight of equipment. Conventional metal machining and forming techniques used in the aeronautical industry include quality control and monitoring of the parts produced, to ensure that the door is assembled in compliance with current standards. However, these metal doors are heavy and require considerable assembly and installation time: they do not correspond to the development of new aircraft with reduced mass. What's more, the assembly of multiple parts, in particular by rivets, creates local stress concentration sites that can lead to static failure or crack propagation in these parts: a maintenance program for the aircraft door is then put in place to periodically inspect these stress concentration sites.

Furthermore, patent document US2009078826A1 presents a conventional aircraft door whose panels and stiffeners are made of composite fiber. Each of these structural parts is individually manufactured using a fiber deposition and resin transfer molding process. These composite fiber doors are lighter than their metal counterparts. However, assembly and installation times are still considerable.

In order to reduce the need for rivets, as well as to space out maintenance program inspections, patent document US2004021038A1 presents a metal door whose panels and stiffeners are machined in a single piece. However, the mass of such a door remains close to that of a conventional door.

Another approach to manufacturing complex composite structures uses a so-called monoblock process, in which the entire structure is manufactured completely as a single block, i.e. without the need to assemble its constituent parts. Patent document US2014154458 presents a composite structure in which fastening fittings are incorporated during manufacture of the composite structure. In patent document US2010294888, fastener insertion zones are molded directly into the one-piece composite structure. However, this manufacturing process requires specific, complex tooling and long lead times.

### DESCRIPTION OF THE INVENTION

In order to overcome the above-mentioned drawbacks of the state of the art, the main aim of the invention is to improve the manufacture of a composite structure—such as an aircraft door—in terms of optimization and adaptation to high rate increases.

For this purpose, the invention involves the production of an aircraft door in composite material, a rough shape of which, hereinafter referred to as “the core”, is produced using a monoblock process, i.e. in a single piece. This core is then machined, and additional structural elements are assembled. This two-stage production process optimizes manufacturing times and processes, and enables the door structure to be adapted to the rest of the structure to which it is then installed.

More specifically, the present invention relates to a process for manufacturing a composite stiffened structure comprising a panel and at least one stiffener. The manufacturing process involves the following steps to obtain a one-piece core:
fiber draping of the panel and stiffener elements;
assembly of said stiffener elements on the panel;
curing of the assembly and obtaining the one-piece core;
which are followed by steps to finalize the stiffened structure from the monoblock core into a hybrid monoblock structure, namely: —machining the monoblock core;
manufacturing additional structural elements to stiffen the stiffened structure and support installation parts;
combining the additional structural elements with the machined monoblock core.

Advantageously, the production of a one-piece core made up of the panel and the stiffeners reduces assembly phases and the number of mechanical fasteners, as the one-piece core is baked. In addition, the core structure can be adapted by modifying the draping and position of the panel and stiffener elements.

Advantageously too, the manufacture and assembly of additional structural elements simplifies the production of the one-piece core. With fewer components, the core is quicker and easier to manufacture. What's more, the additional structural elements complete the core structure, enabling it to be adapted to different needs. The same core can thus be used for different purposes, with the additional structural elements providing the specific features required for these different needs and uses. The core is therefore an easily adaptable base, not only in terms of design but also in terms of assembly, with the addition of supplementary structural elements. This facilitates parts management by limiting the number of part numbers.

According to some preferred forms of implementation taken alone or in combination:
the draping step is automated;
draping superimposes structural fiber plies with sacrificial fiber plies that will be partially eliminated during the core machining step;
the machining of the monoblock core includes steps for trimming the panel and cutting at least one end of the stiffeners to predetermined dimensions;
the machining of the monoblock core is performed at the level of the sacrificial fiber plies;
the draping of the stiffener elements is performed directly according to a predetermined final geometry;
additional structural elements are made of composite material and draped in fiber;
curing is performed in an autoclave-type oven, and
additional structural elements and the monoblock core are cured simultaneously.

Advantageously, automated draping enables productivity gains in terms of time and raw material.

It is also advantageous to drape the stiffeners according to a predetermined final geometry, thus dispensing with traditional flat draping followed by hot forming. Firing the whole assembly in an autoclave saves time and equipment, as a single firing tool is all that's needed for all the elements of the structure. What's more, depending on the size of the autoclave, several cores can be fired at the same time, making it possible to meet high output requirements while limiting the amount of tooling required.

The invention also relates to a one-piece hybrid composite aircraft door with a stiffened structure produced using the above process, this door including:
a one-piece core of composite material constituting a panel and at least one stiffener, each stiffener having a web and a heel;
additional structural elements assembled in combination with this one-piece core to form a functional assembly.

Advantageously, such a hybrid monoblock composite structure door combines the structural benefits of a monoblock structure with the flexibility of assembled structures.

The monoblock core automates manufacturing and enables part of the structure to be assembled by co-consolidation during curing, without the need for mechanical fasteners, which can adversely affect the material's mechanical properties. On the other hand, a purely one-piece structure has the disadvantage of being lacking in adaptability, particularly during the molding and tooling phases, which rules out its use for mass production. The monoblock core therefore simplifies the structure to be molded and the tooling required, while the rest of the door structure is assembled using conventional fasteners.

According to preferred embodiments: —the sacrificial fiber plies of the monoblock core are made of fiberglass;
the additional structural elements are chosen from edge frames installed on the panel perpendicular to the stiffeners, stops, joints, functional element supports and/or door fasteners.

Advantageously, the glass fibers are neutral and insulating, providing in particular a barrier against electrochemical reactions that can lead to galvanic corrosion of metal elements. The glass fibers also enable rapid visual inspection of the machining process, to check that the structural folds have not been damaged by the machining.

### DESCRIPTION OF THE FIGURES

Further features and advantages of the present invention will become apparent from the following detailed embodiment, without limiting the scope thereof, with reference to the appended figures, which show, respectively:

FIG. 1, a perspective view of a one-piece hybrid door according to the invention;

FIG. 2, an exploded perspective view of the panel elements and stiffeners of the door shown in FIG. 1;

FIG. 3, a perspective view of the one-piece core of this door after firing;

FIG. 4, a perspective view of the one-piece core after trimming of the door; and

FIG. 5, an exploded perspective view of the monoblock core shown in FIG. 4 and additional structural elements of the door shown in the preceding figures.

### DETAILED DESCRIPTION

In the figures, identical reference signs refer to the same element and to the corresponding passages in the description.

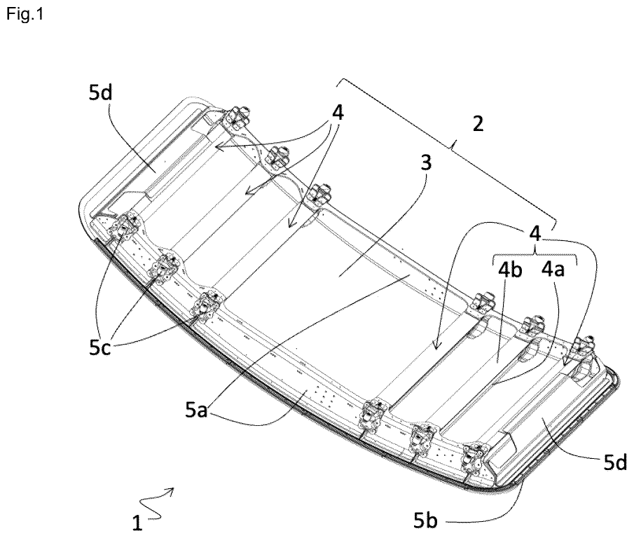

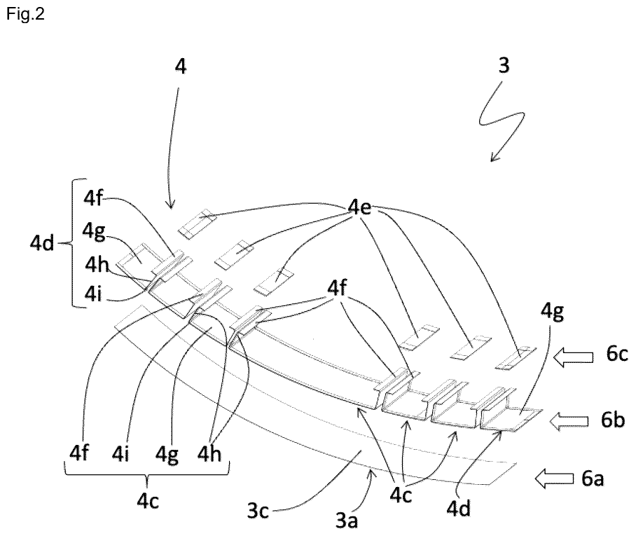

FIG. 1 shows a one-piece hybrid composite aircraft door 1 with a stiffened structure. This door 1 includes:
a one-piece core 2 made of composite material constituting a panel 3 and six stiffeners 4, each stiffener 4 having a web 4a and a heel 4b;
Edge;
frames 5a installed on the panel 3 perpendicular to the stiffeners 4;
Peripheral;
joints 5b;
stops 5c for holding the door 1 in the aircraft fuselage (not shown);
closing plates 5d which limit deformation of the ends of panel 3 when the aircraft is pressurized;
door fasteners (not shown) on this fuselage;
functional element supports (cf. FIG. 2),
the frames 5a, joints 5b, stops 5c, fasteners and supports being assembled in combination with the one-piece core 2 to form a functional and structural assembly.

The door structure 1 thus obtained is structurally complete and dimensioned for installation in the aircraft after attachment of its functional elements, in particular handles, fasteners and door opening systems.

FIG. 2 illustrates the bottom element 3c of the panel 3 and the intermediate, end 4d and top 4e elements of the stiffeners 4 used to manufacture the one-piece core 2 of the aircraft door 1, which forms a composite stiffened structure. The manufacturing process for such a door 2, which in this example comprises a panel 3 and six stiffeners 4, involves the following steps to obtain the one-piece core:
fiber draping of the bottom element 3c of the panel 3 as well as of the spacer elements 4c, end 4d and top 4e of each stiffener 4;
assembly of the spacer elements 4c, end 4d and top 4e of the stiffeners 4 on the bottom element 3c of the panel 3;
curing of the assembly and obtaining the one-piece core.

The stiffened structure is then finalized from the monoblock core 2 into a hybrid door monoblock structure 1 obtained in the following steps: —
machining the monoblock core 2;
manufacturing additional structural elements (not shown) to stiffen the stiffened structure and support installation parts;
combining the additional structural elements with the machined monoblock core 2.

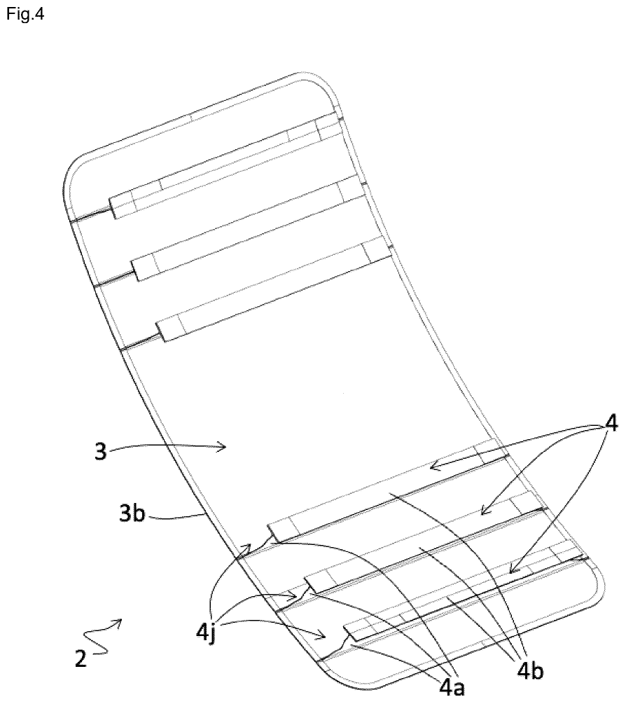

More specifically, the bottom element 3c of the panel 3 and the intermediate, end 4d and top 4e elements of the stiffeners 4 are draped in carbon fiber and superimposed on three levels:
the first level 6a consists of the bottom element 3c forming the outer surface of panel 3—i.e. the skin 3a;
the intermediate level 6b is made up of intermediate elements 4c and end elements 4d, which form the inner face of the panel 3, as well as the core 4a (see FIGS. 1, 4) and the support 4f for the heels 4b (see FIGS. 1, 4) of the stiffeners 4;

the last level 6c is made up of the upper elements 4e forming said heels 4b of the stiffeners 4.

The base elements 3c and top elements 4e—respectively of the first level 6a and the last level 6c—have a surface topology dimensioned to the size of the panel 3 and the heels 4b of the stiffeners 4. The base elements 4c and 4d of the intermediate level 6b have overall “U”- or “L”-shaped cross-sections, including: a flat flange 4g facing the base element 3c, all flanges 4g extending to cover the base element 3c;
one (for end elements 4d located at the ends of panel 3) or two (for intermediate elements 4c) half-webs 4h of stiffeners 4 perpendicular to each flange 4g and at the end 4i of this flange 4g, and
a heel support 4f perpendicular to each half-web 4h and at the end of this half-web 4h.

The spacer elements 4c and end elements 4d of the intermediate level 6b are arranged on the skin 3a via the flanges 4g and juxtaposed to one another by bringing the half-webs 4h into contact, with two adjoining half-webs 4h forming a stiffener core 4a. In this example, seven intermediate elements 4c and end elements 4d are present in the intermediate level 6b to produce six stiffeners 4. For this purpose, the two end elements 4d have a single half-web 4h with an “L”-shaped cross-section, while the intermediate elements 4c have two half-webs 4h with a “U”-shaped cross-section.

The draping of the bottom 3c, intermediate 4c, end 4d and top 4e elements of the panel 3 and of the stiffeners 4 is automated and carried out directly according to their predetermined final geometry, in particular according to the “L” and “U” cross-sections of the base elements 4c, 4d of the stiffeners 4 of the intermediate level 6b. Alternatively, these intermediate 4c and end 4d elements can be draped flat and then preformed to obtain their final L and U geometry.

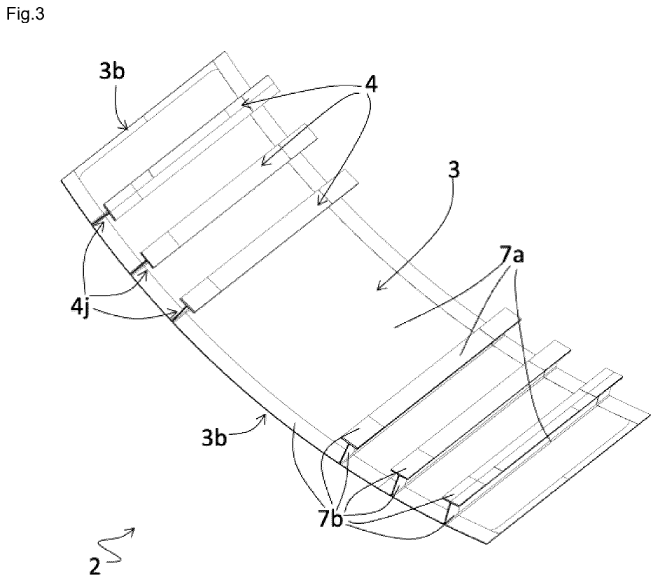

The one-piece core 2 after curing in an autoclave-type oven is illustrated in FIG. 3: after assembly of the bottom 3c, spacer 4c, end 4d and top 4e elements of panel 3 and stiffeners 4, resin is injected into the assembly and the whole assembly is placed in the oven for curing. The resin may be thermosetting or thermoplastic. Alternatively, draping can be carried out with pre-impregnated fibers, in which case curing is performed directly without resin injection. Curing outside the autoclave is also possible, in particular by a known process of resin infusion into the assembly.

Draping superimposes structural fiber plies 7a with sacrificial fiber plies 7b, which will be partially removed during the machining stage of the monoblock core 2. The structural fiber plies 7a are responsible for holding the structure together. The draped sacrificial folds 7b make it easier to assemble the monoblock core 2 by using elements with a simple geometry, then part of these sacrificial folds 7b is eliminated by machining to obtain the final dimensions of the monoblock core 2. Thus, these sacrificial folds 7b are located at the edge 3b of the panel 3 and at the ends 4j of the stiffeners 4. In this embodiment, the structural folds 7a are made of carbon fiber for mechanical strength, and the sacrificial folds 7b are made of glass fiber for ease of machining.

FIG. 4 shows the one-piece core 2 after machining, which is carried out at the sacrificial fiber folds 7b. This machining operation involves trimming the panel 3 along its edge 3b and cutting the end 4j of the stiffeners 4 to predetermined dimensions. In this way, the contour of panel 3 is advantageously rounded and its dimensions are adjusted to the opening that this door panel 3 completes. In addition, the stiffeners 4 are cut at their web 4a and heel 4b to meet the dimensional constraints relating to the installation of said door 1.

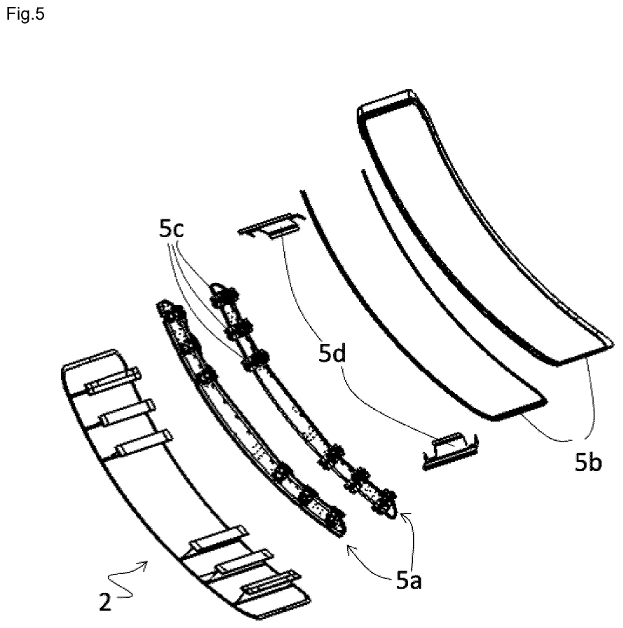

FIG. 5 illustrates the additional structural elements that have been fabricated to be attached to the monoblock core 2. These additional structural elements are intended to consolidate the stiffened structure of the monoblock core 2 so as to be able to support the addition of installation parts: these additional structural elements are chosen from edge frames 5a installed on the panel perpendicular to the stiffeners 4, stops 5c, closure plates 5d, system element supports, joints 5b and/or door fasteners (not shown). In particular, the edge frames 5a can be made of composite material and draped in fibers, the curing of the edge frames 5a and the monoblock core 2 advantageously being carried out simultaneously.

These additional structural elements are assembled by conventional methods using rivet-type fasteners or screw/nut assemblies, or epoxy glue or equivalent. The resulting door is thus a hybrid door in which composite or metal structural elements are assembled on a one-piece composite core.

This approach makes it possible to automate the draping and thus the fiber orientation of the door's composite parts, resulting in improved precision and manufacturing speed for these composite parts. The one-piece core also reduces the number of mechanical fasteners that can adversely affect the material's mechanical properties: each drill hole creates a zone of local overstress, which can cause the door structure to crack.

These mechanical fasteners are also particularly advantageous in terms of the structure's adaptability, given the resources required in terms of equipment, research and costs for any future modifications or upgrades to the structure. A hybrid structure with a one-piece core, the object of the present invention, therefore combines the advantages of a one-piece structure with the benefits of limited use of mechanical fasteners.

The invention is not limited to the embodiment and implementation examples described and shown. For example, the panel and stiffeners can be draped manually.

In addition, materials other than composites can be used to produce the additional structural elements, notably plastics or metals such as aluminum, steel, nickel or titanium alloys: these elements are then produced using conventional machining and shaping methods.

Other types of fiber can also be used for draping: in particular carbon fibers for all the structural and sacrificial folds, or any other fiber offering suitable mechanical characteristics for use with the resulting hybrid monoblock structure.

1. A manufacturing process for a composite stiffened structure comprising a panel (3) and at least one stiffener (4), the method composing the following steps to obtain a monoblock core (2):
fiber draping of the elements (3c, 4c, 4d, 4e) of the panel (3) and of the stiffeners (4);
assembling said elements (3c, 4c, 4d, 4e) of the stiffeners (4) on the panel (3);
curing of the assembly and obtaining of the monoblock core (2);
wherein baking is carried out in an autoclave-type oven and in that the steps for obtaining the monoblock core (2) are followed by the following steps for finalizing the stiffened structure from the monoblock core (2) into a hybrid monoblock structure:
machining of the monoblock core (2);
manufacture of additional structural elements designed to consolidate the stiffened structure and support installation parts;
combination of the additional structural elements with the machined monoblock core (2).

2. The manufacturing process according to claim 1, wherein the draping step is automated.

3. The manufacturing process according to claim 1, wherein the draping step superimposes structural fiber plies (7a) with sacrificial fiber plies (7b).

4. The A manufacturing process according to claim 1, wherein machining of the one-piece core (2) comprises steps of trimming the panel (3) and cutting at least one end (4j) of the stiffeners (4) to predetermined dimensions.

5. The manufacturing process according to a ne of claim 1, wherein machining of the monoblock core (2) is performed at the sacrificial fiber plies (7b).

6. The manufacturing process according to claim 1, wherein the draping of the elements (4c, 4d, 4e) of the stiffeners (4) is carried out directly according to a predetermined final geometry.

7. The manufacturing method according to claim 1, wherein the additional structural elements are made of composite material and draped in fiber.

8. The manufacturing method according to claim 1, wherein the additional structural elements and the one-piece core (2) are fired simultaneously.

9. A hybrid one-piece composite aircraft door (1) with a stiffened structure produced using the process according to of claim 1, wherein the door (1) comprises:
the one-piece core (2) of composite material constituting a panel (3) and at least one stiffener (4), each stiffener (4) having a web (4a) and a heel (4b);
additional structural elements (5a, 5b, 5c) assembled in combination with the one-piece core (2).

10. The hybrid one-piece composite door (1) according to claim 9, wherein the sacrificial fiber plies (7b) of the one-piece core (2) are made of glass fiber.

11. The hybrid one-piece composite door (1) according to claim 9, wherein the additional structural elements are chosen from edge frames (5a) installed on the panel (3) perpendicular to the stiffeners (4), stops (5c), seals (5b), functional element supports and/or door fasteners.
